(19) United States
(12) Patent Application Publication
(10) Pub. No.: US 2016/0221320 A1
(43) Pub. Date: Aug. 4, 2016

(54) METHOD OF MAKING NAKED MARBLE DESIGN ART

(71) Applicant: Donato PARTIPILO, Seaford, NY (US)

(72) Inventor: Donato PARTIPILO, Seaford, NY (US)

(21) Appl. No.: 14/610,128

(22) Filed: Jan. 30, 2015

(51) Int. Cl. B32B 37/12; B32B 3/14; B32B 9/00; B32B 38/00; B32B 37/18

(52) U.S. Cl. CPC B32B 37/1284; B32B 38/0004; B32B 37/18; B32B 9/002; B32B 3/14; B32B 2318/04; B32B 2451/00; B32B 2250/02; B32B 2255/00

(57) ABSTRACT

A method for making Naked Marble Design art independent of grout is provided. The method includes a plurality of marble or stone assemblage pieces being bound together with a transparent adhesive, enhancing the depth of perspective and intensifying the clarity of a predetermined design. The plurality of assemblage pieces of the predetermined design may be secured to a suitable frame with a frame adhesive. Then a suitable amount of the transparent adhesive may be applied between adjacent pieces so as to affect a naked marble look for the predetermined design.

### BACKGROUND OF THE INVENTION

The present invention relates to the field of decorative art and, more particularly, to a method for creating naked marble designs using marble or stone cut into various size pieces, independent of grout, and so making use of natural light to enhance new designs thereof.

The traditional mosaic is the art of creating images with an assemblage of small pieces of hard material such as stone, tile or glass. Traditionally, marble and stone designs are set in grout. This limits the intensity of the art and the display of its natural beauty as the grout is opaque, blocking natural light. Grout, or other construction material used to bind the mosaic pieces, can collect dirt, mildew and bacteria, resulting in a potentially dirty and unsanitary assemblage.

As can be seen, there is a need for a clean process for creating art comprised of pieces of marble or stone, independent of grout, and so making use of natural light to enhance new designs thereof.

### SUMMARY OF THE INVENTION

In one aspect of the present invention, a method for creating an assemblage artwork using marble or stone independent of grout comprises: providing a plurality of assemblage pieces for a predetermined design; securing the plurality of assemblage pieces along a suitable frame, wherein the plurality of assemblage pieces are arranged in the predetermined design; and applying a suitable amount of the transparent adhesive between adjacent pieces, whereby effecting a naked marble look for the predetermined design.

In another aspect of the present invention, a method for creating an assemblage artwork using marble or stone independent of grout comprises: providing a plurality of assemblage pieces for a predetermined design; cutting each assemblage piece to a suitable size for the predetermined design; securing the plurality of assemblage pieces along a suitable frame, wherein the plurality of assemblage pieces are arranged in the predetermined design; applying a suitable amount of the transparent adhesive between adjacent pieces; adding at least one tint to the transparent adhesive; and drying the assemblage artwork, whereby affecting a naked marble look for the predetermined design.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a perspective view of an exemplary embodiment of the present invention;

FIG. 3 is a perspective view of an exemplary embodiment of the present invention;

FIG. 4 is a section view of an exemplary embodiment of the present invention, taken along line 4-4 of FIG. 3;

FIG. 5 is an enlarged view of FIG. 4; and

FIG. 6 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for creating art generally using assemblage pieces of marble or stone, independent of grout. The method includes a plurality of assemblage pieces being bound together with a transparent adhesive, enhancing the depth of perspective and intensifying the clarity of a predetermined design. The plurality of marble or stone pieces of the predetermined design may be secured to a suitable frame with a frame adhesive. Then a suitable amount of the transparent adhesive may be applied between adjacent pieces so as to effect a naked marble look for the predetermined design.

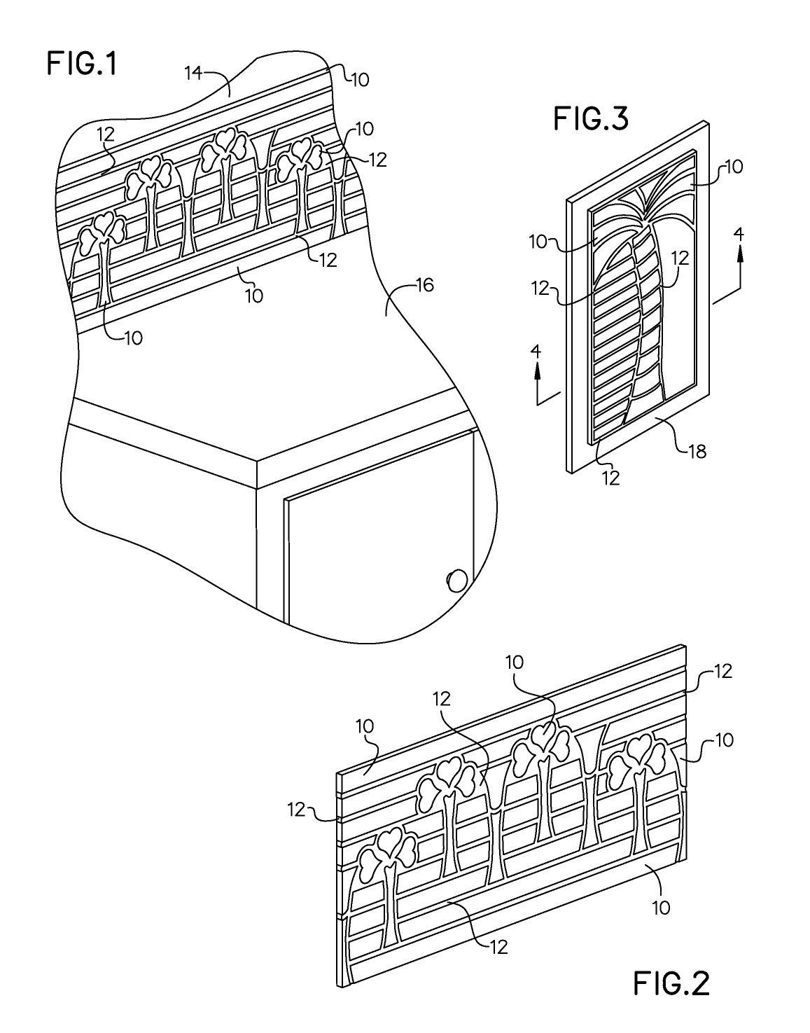

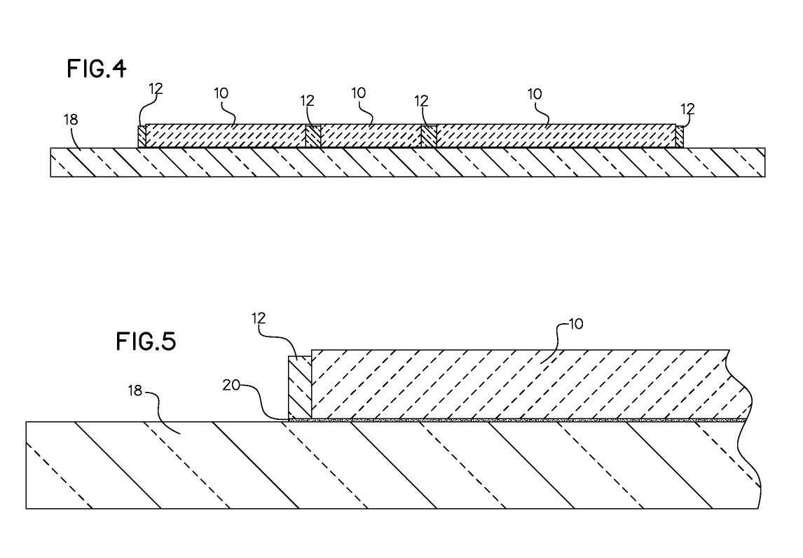

Referring to FIGS. 1 through 5, the present invention embodies a method for creating art using pieces of marble or stone independent of grout, and so making use of natural light to enhance new designs thereof. The method includes a plurality of assemblage pieces 10 being bound together with a transparent adhesive 12, enhancing the depth of perspective and intensifying the clarity of a predetermined design. The transparent adhesive 12 may include glue, acrylic-based substances and the like.

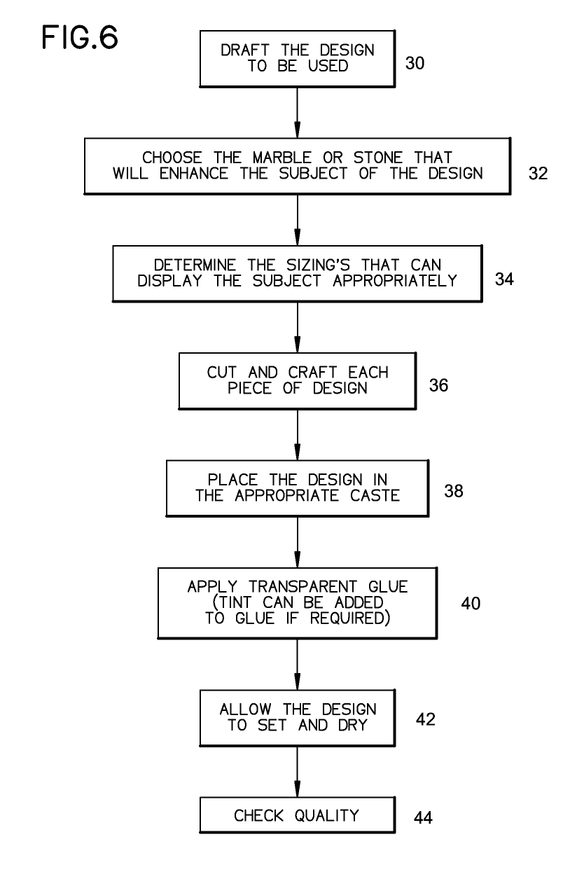

Referring to FIG. 6, in step 30 the method includes the drafting of a predetermined design to be used, followed by the choice of the plurality of assemblage pieces 10, such as marble or stone, which will enhance the subject of the design, in step 32. In step 34, a user may determine the sizing of the plurality of assemblage pieces 10 that can display the subject appropriately, followed by the cutting and crafting of assemblage piece 10 for the predetermined design, in step 36.

In step 38, the user may secure the plurality of assemblage pieces 10 of the predetermined design to a suitable frame 18 with a frame adhesive 20, as illustrated in FIG. 5. The frame 18 may be castes, casements, sheet of material and the like that may hold the predetermined design for different applications, such as walls 14, floors, backsplashes of countertops 16, decos, free standing decorative art, decorative panels used in furniture and the like. The user may interconnect the frame 18 and each assemblage piece 10 with the frame adhesive 20. Then the user may apply a suitable amount of transparent adhesive 12 between the plurality of assemblage pieces 10 so as to effect a naked marble design, in step 40. In step 40, tint can be added to transparent adhesive 12 as desired. In step 42, the design will set and dry. Once set and dry, the predetermined design will be quality checked, in step 44.

The resulting naked marble design eliminates the use of grout and so the need for grout-related layout and cutting.

It should be understood, of course, that the foregoing relates to exemplary embodiments of the invention and that modifications may be made without departing from the spirit and scope of the invention as set forth in the following claims.

What is claimed is:

1. A method for creating an assemblage artwork using marble or stone independent of grout, comprising:
providing a plurality of assemblage pieces for a predetermined design;
securing the plurality of assemblage pieces along a suitable frame, wherein the plurality of assemblage pieces are arranged in the predetermined design; and
applying a suitable amount of the transparent adhesive between adjacent pieces,
whereby affecting a naked marble look for the predetermined design.

2. The method of claim 1, wherein the plurality of assemblage pieces are secured along the suitable frame by a frame adhesive.

3. The method of claim 1, wherein the suitable frame is a caste.

4. The method of claim 1, wherein the suitable frame is a casement.

5. The method of claim 2, wherein the suitable frame is a sheet of material.

6. The method of claim 1, further including cutting each assemblage piece to a suitable size for the predetermined design.

7. The method of claim 1, further including adding at least one tint to the transparent adhesive.

8. The method of claim 1, further including drying the assemblage artwork.

9. A method for creating an assemblage artwork using marble or stone independent of grout, comprising:
providing a plurality of assemblage pieces for a predetermined design;
cutting each assemblage piece to a suitable size for the predetermined design;
securing the plurality of assemblage pieces along a suitable frame, wherein the plurality of assemblage pieces are arranged in the predetermined design;
applying a suitable amount of the transparent adhesive between adjacent pieces;
adding at least one tint to the transparent adhesive; and
drying the assemblage artwork,
whereby affecting a naked marble look for the predetermined design.
